(19) United States
(12) Patent Application Publication
(10) Pub. No.: US 2015/0278957 A1
(43) Pub. Date: Oct. 1, 2015

(54) Method of Determining Sufficient Financial Resources for Retirement

(71) Applicants: Richard G. Wiwi, Moraga, CA (US); John J. Mayerhofer, Oakland, CA (US)

(72) Inventors: Richard G. Wiwi, Moraga, CA (US); John J. Mayerhofer, Oakland, CA (US)

(21) Appl. No.: 14/675,739

(22) Filed: Mar. 31, 2015

Related U.S. Application Data
(60) Provisional application No. 61/972,987, filed on Mar. 31, 2014.

(51) Int. Cl. G06Q 40/06; G06Q 40/00

(52) U.S. Cl. CPC G06Q 40/06; G06Q 40/10

(57) ABSTRACT

A method of determining sufficient financial resources for retirement and is intended to help a user stress test whether or not their current financial status is sufficient to support them through to the end of their life. The method is executed by means of software as demographic information, a plurality of income factors, and a plurality of expenditure factors are defined by the user. The defined parameters are then subjected to randomization within a total number of years alive in order to account for the uncertainty of the each different parameters. Then lifetime asset values for the total number of years alive are calculated by completing a single iteration. Additionally, multiple iterations are utilized to display a probability ratio for a positive probability result or a negative probability result.

The current application claims a priority to the U.S. Provisional Patent application Ser. No. 61/972,987 filed on Mar. 31, 2014.

### FIELD OF THE INVENTION

The present invention relates generally to the field of financial security. More specifically, the present invention is a method of determining sufficient financial resources for retirement which is intended to help a user in determining whether or not their financial assets are sufficient to support them through to the end of their life. The present invention is also capable of determining whether or not the user's financial assets are sufficient to leave an inheritance to family members after the death of the user. The present invention accomplishes the determination of whether or not the user's assets are sufficient by simulating income and outcome over several years with multiple iterations. The simulation is based upon randomization and multiple iterations so that the simulation is able to yield an accurate success rate which accounts for the worst case and the best case scenarios.

### BACKGROUND OF THE INVENTION

The economy of the modern world is based largely upon free market and regulated market trading which operated upon the concept of supply and demand. Supply and demand can be described most simply as a model of the price of goods within a given market; the two factors of supply and demand can fluctuate and can affect prices of goods within the market. In most modern economies, market trading is facilitated through the use of a currency which serves as a medium for exchange between parties. Currency, also known as money, is typically exchanged between two or more parties in exchange for goods or services. Currency functions through its wide acceptance among a given population. For example, if one party pays for a product using currency, it is accepted that the merchant receiving that payment can turn around and use that currency to purchase other items or services which they may need to continue the operation of their business. Thus, currency is able to act as a medium for all exchanges of goods and services as goods and services that an individual or organization can purchase directly related to the amount of currency individual or organization has. As a result of this fact, the primary goal of most individuals and organizations within a given economy is the accumulation of currency with which to purchase needed and desired goods and services.

The accumulation of wealth is a major concern for many individuals and organizations. Organizations such as companies typically accumulate wealth by selling some product or providing some service and making profit for doing so. Individuals typically accumulate wealth through employment. Employment typically provides some income of money which the individual can then use however they see fit. In addition to enabling the purchase of goods and services, money can be invested into companies in the form of stocks and used to purchase shares on a wide variety of different financial markets which operate on almost exclusively financial transactions as opposed to physical exchange of goods. Examples of financial markets include but are not limited to stock markets, commodity markets, bond markets, currency exchanges, and derivatives markets. Many of these markets do carry significant risk of loss of money, however they also carry the potential to dramatically increase in value; allowing the owners to sell the shares for much more money than they purchased them for. Thus, such financial markets can be extremely useful in helping individuals accumulate wealth so long as they are willing to accept the risk that sometimes they will lose more money than they gain.

The potential to accumulate wealth by investing money into various financial markets has lead to extensive development in the area of financial planning devices which are intended to help a user determine the best course of action to maximize their accumulation of money. Such devices are commonly referred to as financial calculators and almost all of such financial calculators are focused primarily upon arriving at future accumulation values. Most currently available financial calculators utilize some sort of financial model or follow some investment strategy with a plurality of variables serving as the input. Unfortunately, financial calculators also typically lack any sort of dynamic interaction between variables which are input by the user. This lack of interaction means that an accurate determination of future accumulation is hard to achieve, as the calculations are based upon variables which may actually be dependent upon one another. Thus, two major problems with currently available financial calculators can be identified: 1) their linear calculation methods do not reflect real world uncertainty in financial markets, and 2) they focus almost entirely upon the concept of accumulation as opposed to decumulation. Decumulation can be described as drawing down retirement assets. Thus, the concept of decumulation is becoming more and more relevant as the population of the US ages and begins to enter retirement.

The generation born between 1946 and 1964—the “baby boomers”—flooded the labor market starting in the early 1960's and extending through the early 1980's. The baby boomers experienced rising incomes throughout the remainder of the 1980's to the turn of the century. At the same time, American businesses were coming under increasing pressure to reduce the cost of doing business in order to stay competitive in the face of international competition. As a result, a major dramatic shift away from defined “benefit” retirement plans to defined “contribution” plans with a shift to employee responsibility for “contributions”. Voluntary employee contributions, or self funded “qualified” funding, gave impetus to a mushrooming financial industry. The resulting emphasis was overwhelmingly on accumulation planning. As prior art morphed into more and more complex, still static forms it is more often than not “sponsored” by investment or insurance product purveyors who possessed sufficient computing power. Also, more often than not, prior art's objective, implicitly or explicitly, is in the service of marketing specific product types—insurance or securities.

Since the turn of the 21^{st} century, there have been many changes in demographic and socio-economic conditions along with unpredicted prolonged market losses. These new social and economic developments have coupled with advances in analytical technology to give rise to improvements in financial planning tools. These improvements have led to increased flexibility and complexity in financial calculators. Although being vast improvements over their predecessors, newer financial planning calculators typically lack an intuitive user interface. Additionally, current financial calculators fail to solve the fundamental error of linear, predictive-based modeling; real world financial occurrences are exceedingly difficult, if not impossible, to accurately predict using a linear model. In late 2007 up through the first quarter of 2009 the unpredictable and non-linear nature of asset values was yet again demonstrated by dramatic fluctuations in financial markets. The turn of the century also saw the initial cohort of the baby-boomer generation entering their retirement years. By the end of the first decade of the new millennium 10,000 individuals per day are entering the 65 and over cohort. This will continue for the next two decades. The continuing mass retirement of the baby boomer generation puts a new emphasis on decumulation and retirement income planning. Many retirement Income planning models have emerged in recent years. The earliest examples are developed by the same large institutional product vendors which are already heavily invested in accumulation calculators. As a result of this, most decumulation calculators are little more than the inverse of accumulation calculators; they are based on simple assumptions of the rate of withdrawal and incorporate similar accumulation assumptions with regard to past average market performance. With increased understanding that the strategies for accumulating assets are quite different from decumulation metrics, there is a need for a new method of stress testing long term decumulation of wealth which is based upon non-linear dynamic variables which also accounts for some degree of interaction between these variables.

It is therefore an object of the present invention to introduce a retirement success determinator system and method which focuses upon solving issues discussed above. It is an object of the present invention to utilize user input parameters to simulate the decumulation of wealth over a defined period of time. The present invention accounts for uncertainty by running the simulation based upon random generation of numbers which are used to systematically modify the initial state of each parameter; certain parameters may also affect the way other parameters are modified during the simulation. In other words, the present invention does not look into the history of financial markets to find a sequence of events that achieves a high probability desired outcome under a series of input parameters. The present invention assumes neither replication of historical outcomes nor identical magnitudes of change in major financial markets The present invention fills analytical gaps created by the prior art while simultaneously accounting for the uncertainty reality of the financial markets. Additionally, it is an object of the present invention to provide the probability of future decumulation by running the simulation repeatedly for some number of iterations. The present invention uses randomization to calculate the percentage of times where the simulation indicates a successful retirement. Successful retirement is defined as when the user still has a positive account balance at the end of the simulation which is the projected estimate of when the user dies.

### BRIEF DESCRIPTION OF THE DRAWINGS

FIG. 1 is a diagram illustrating the inputs, the modules, and the outputs used in the present invention.

FIG. 2 is a diagram illustrating the influential components of the demographic financial module for the present invention.

FIG. 3 is a diagram illustrating the influential components of the cost module for the present invention.

FIG. 4 is a diagram illustrating the influential components of the income module for the present invention.

FIG. 5 is a diagram illustrating the exogenous events taken into account by the present invention.

FIG. 6 is a diagram illustrating the taxation factors taken into account by the present invention.

FIG. 7A is a diagram illustrating the influential components of the cash flow module for the present invention.

FIG. 7B is a diagram illustrating the risk/reward factors taken into account by the present invention.

FIG. 8 is a diagram illustrating the influential components of the report module for the present invention.

FIG. 9 is a flowchart depicting the overall process of the present invention.

FIG. 10 is a flowchart depicting the process of randomizing the adjustment factor and the annual inflation rate for the present invention.

FIG. 11 is a flowchart depicting the process of managing savings for the present invention.

FIG. 12 is a flowchart depicting the process of managing retirement earnings for the present invention.

FIG. 13 is a flowchart depicting the process of defining and managing expenditure factors for the present invention.

FIG. 14 is a flowchart depicting the process of managing two earners within a household earning entity for the present invention.

FIG. 15 is a flowchart depicting the process of managing an extraordinary expense and taxes for the present invention.

FIG. 16 is a flowchart depicting the process of managing a sweep account for the present invention.

FIG. 17 is a flowchart depicting the process of managing residency information and property capital for the present invention.

FIG. 18 is a flowchart depicting the process of calculating the probability ratio with and without the home sale for the present invention.

FIG. 19 is a flowchart depicting the process of calculating the legacy hurdle with and without the home sale for the present invention.

FIG. 20 is a flowchart depicting the process of managing the current annual salary for the present invention.

### DETAIL DESCRIPTIONS OF THE INVENTION

All illustrations of the drawings are for the purpose of describing selected versions of the present invention and are not intended to limit the scope of the present invention.

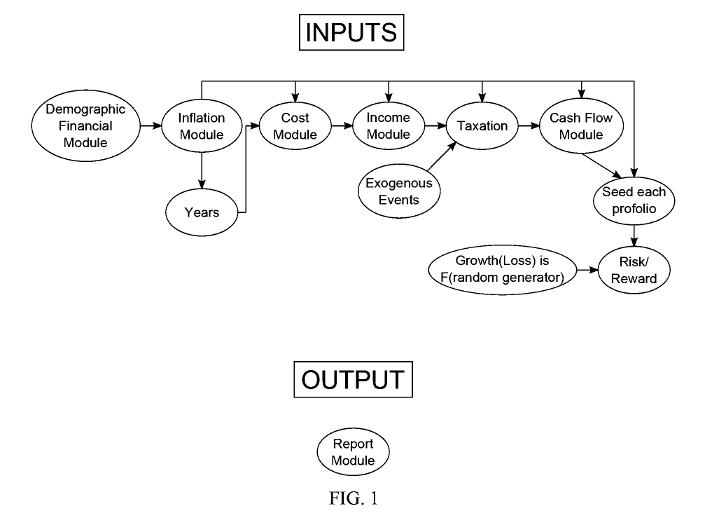

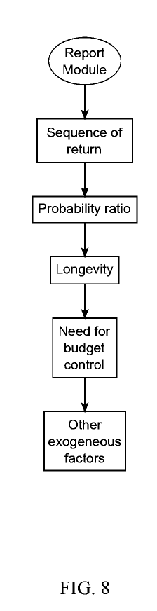

The present invention is a method of determining sufficient financial resources for retirement and is intended to help a user test whether or not their current financial status is sufficient to support them through to the end of their life as shown in FIG. 1-8. The present invention is focused upon the concept of decumulation which refers to the steady utilization of wealth over time; this is of particular interest to those who are retiring and are want to know whether or not their current financial assets are sufficient to support them for the rest of their lives. The method of the present invention is executed by means of software, wherein a user operated computing device allows the user to input parameters into the software which are crucial to the outcome of the calculations. The computing device may be virtually any modern computing device which has enough processing power and storage space to host the software of the present invention. Some examples of the computing devices which may be suitable as the user device for the present invention include, but are not limited, to personal computers, tablet computers, laptop computers, and smart phones. The software of the present invention is perhaps the most important part of the present invention, as it is responsible for accepting parameters from the user and analyzing those parameters to provide meaningful and informative results to the user. Analysis is achieved through a simulation of income and outcome over several years which are performed by using the input parameters. The simulation is based upon randomized numbers which accounts for the principal of uncertainty of financial markets, thereby providing the most realistic indication of whether or not a user's current financial assets are sufficient to support them through to the end of their life.

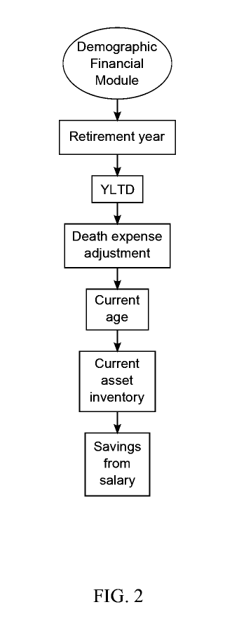

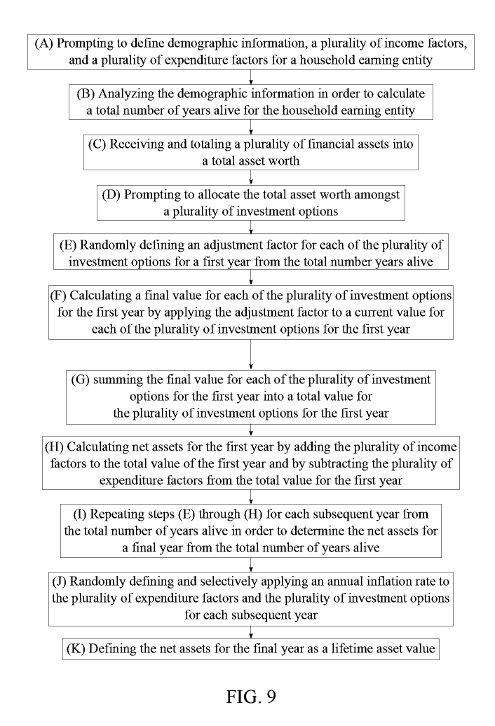

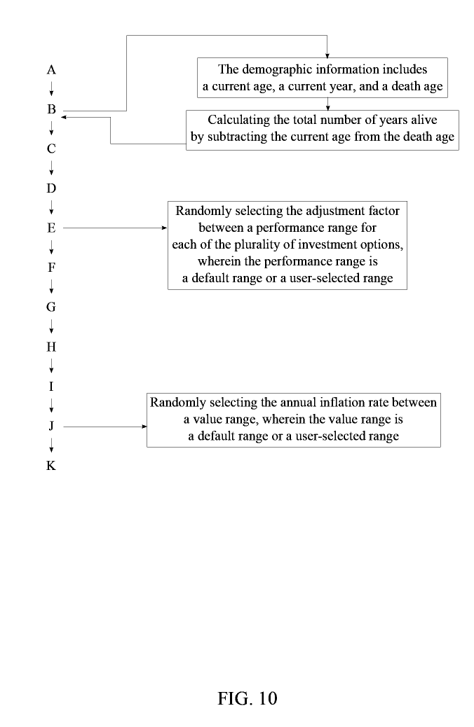

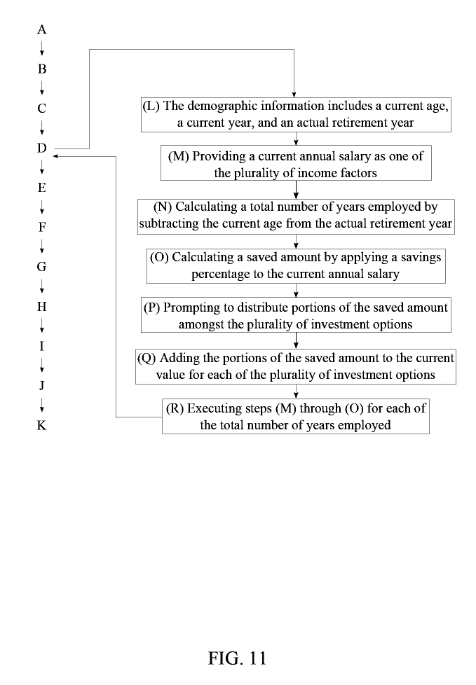

In reference to FIG. 1, FIG. 9, FIG. 10, and FIG. 11, the present invention first prompts the user to define demographic information, a plurality of income factors, and a plurality of expenditure factors for a household earning entity. In reference to FIG. 2, the demographic information is responsible for collection several different input parameters which define the demographics status for the household earning entity. The household earning entity within the present invention can be defined for two individuals or a single individual so that the present invention can accommodate an individual retiree or a pair of retirees. The demographic information is defined by the user and includes the following input parameters such as a current age, a current year, and a death year, an actual retirement year, an eligible retirement year, a death expense factor, and taxation information.

In reference to FIG. 9, the current age defines the age of the household earning entity with respect to the current year of the present invention. The current year automatically defines a starting year for the present invention which is set to be one year before the current year. The death year is considered as the presumed age at death for the household earning entity.

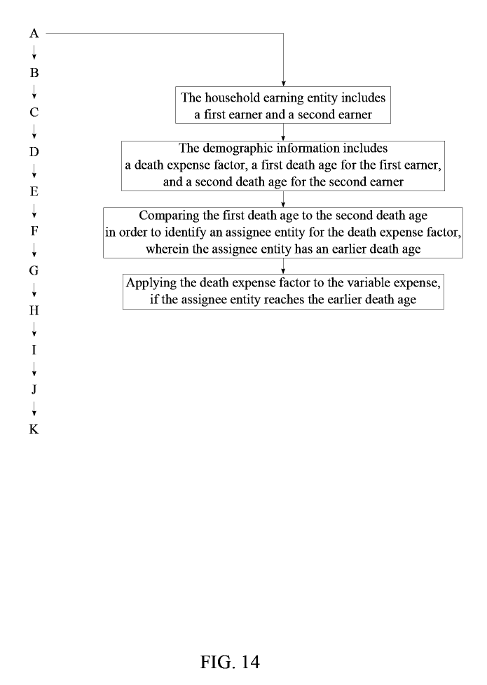

In reference to FIG. 14, the event that the household earning entity includes a first earner and a second earner, the present invention prompts the user to define a death expense factor, a death age for the first earner, and a second death age for the second earner. The death expense factor, which dictates a percentage drop in a variable expense of the plurality of expenditure factors upon the death of one of the earners. More specifically, the present invention compares the first death age to the second death age in order to identify an assignee entity for the death expense factor as the assignee entity has an earlier death age. Then the death expense factor can be applied into the variable expense if the assignee entity reaches the earlier death age.

The eligible retirement year is when a person may first become entitled to full or unreduced retirement benefits such as pension, social security benefits, and medical benefits. The actual retirement year dictates when the household earning entity stops receiving a current annual salary from employment, where the current annual salary is considered to be one of the plurality of income factors.

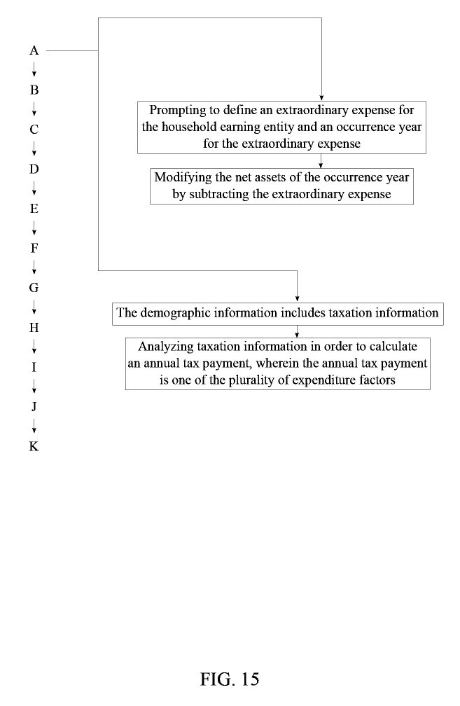

In reference to FIG. 15, the taxation information is intended to account for annual tax payments within the present invention. The taxation information contains current federal and state income tax tables, and uses these tables to calculate the annual tax payments depending upon filing status of the household earning entity. More specifically, the taxation information chooses the appropriate tax table and calculates base and incremental tax rates, where the taxation information preferably assumes that approximately sixty five percent of gross wages for married people, and seventy five percent of gross wages for single people are taxable. In order to start the calculation for the annual tax payment within the present invention, a guess federal rate based on the household earning entity and a state rate based on the residence state have to be entered by the user. Once the demographic information received by the present invention, the present invention automatically calculates a total number of years alive for the household earning entity. The total number of years alive is calculated by subtracting the current age from the death age so that the total number of years alive can be utilized within the present invention when required.

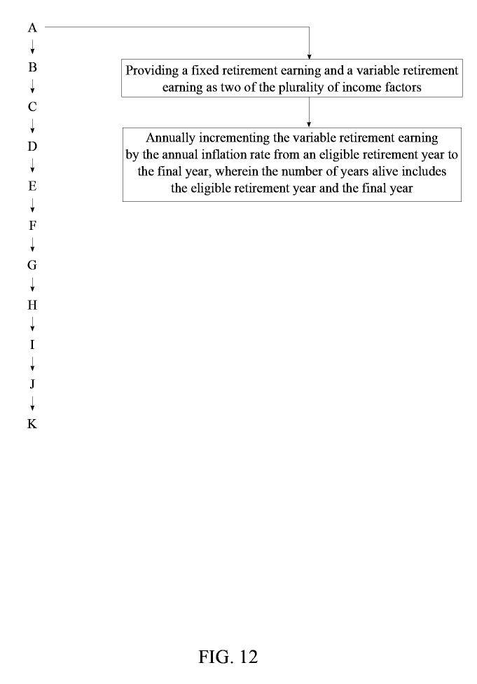

In reference to FIG. 12, the plurality of income factors that ultimately decides the outcome of the present invention includes a fixed retirement earning, a variable retirement earning, and an extraordinary event earning in addition to the current annual salary. The fixed retirement earning stays constant throughout the total number of years alive in such a way that the fixed retirement earning does not increase or decrease overtime. For example, the fixed retirement earning includes, but is not limited, defined benefit plans, pension payments, and annuity payouts.

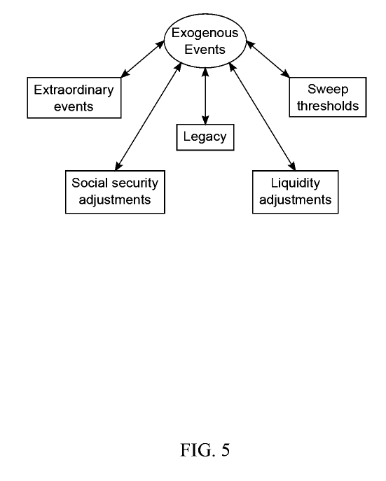

In reference to FIG. 12, the variable retirement earning within the present invention is subjected to an annual inflation rate from the eligible retirement year to a final year of the number of years alive. In reference to FIG. 5, the variable retirement earning includes, but is not limited to, social security payments and certain pensions as the user is able to choose what degree it is affected. Additionally, a social security adjustment factor, which is defined by the user, sets a percentage for years within the present invention where the social security adjustment factor is applied to social security payments. For example, when the social security adjustment factor is 80%, the social security payments are initially set to be paid at 80% of the annual inflation rate; in other words, the social security payments are not assumed automatically adjusted upwards 100% of the time in line with annual inflation rate.

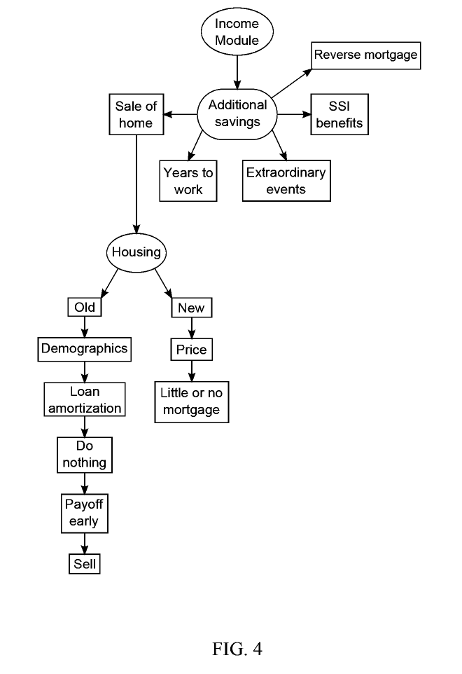

In reference to FIG. 4, the extraordinary event earning accounts for potential random events such as inheritances, death proceeds gifts, gifts, and lottery winnings. Since the extraordinary event earning cannot be predicted, the present invention allows each occurrence of the extraordinary event to be uploaded as it present itself during the total number of years alive. Then the present invention is able update the outcome of the present invention by applying the uploaded information regarding the extraordinary event into the calculation.

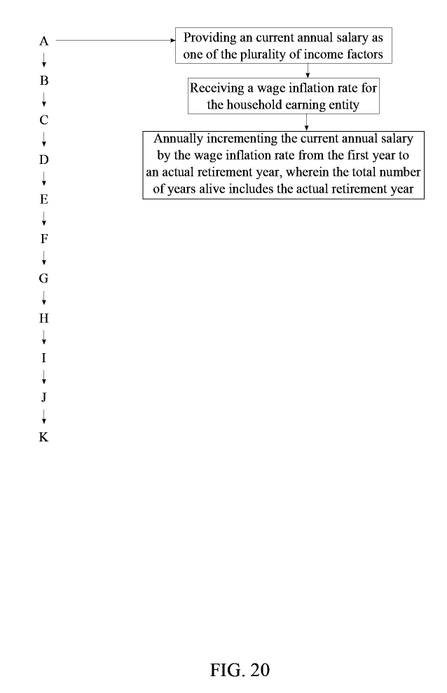

Salaries and wages of the household earning entity represent how much money that the household earning entity can earn on a yearly basis from employment and are defined as the current annual salary within the present invention. In reference to FIG. 20, since the current annual salary is defined as one of the plurality of income factors and a wage inflation rate is applied the current annual salary, the current annual salary changes with a total number of years employed. More specifically, the present invention receives the wage inflation rate for the household earning entity so that the current annual salary can be annually incremented by the wage inflation rate from a first year to the actual retirement year. The wage inflation rate sets an annual percentage increase, which the current annual salary increases, within the present invention and is preferably set to a default value at the beginning. However, the user can also redefine the wage inflation rate for the household earning entity in such a way that the present invention overwrites the default value of the wage inflation rate with the user defined wage inflation rate.

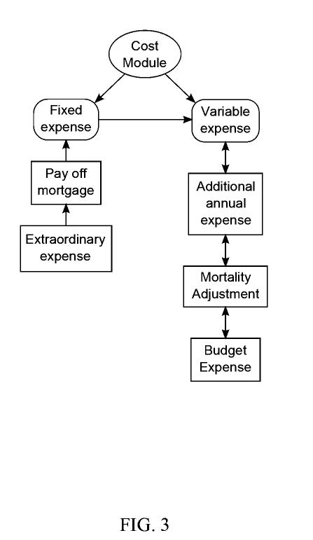

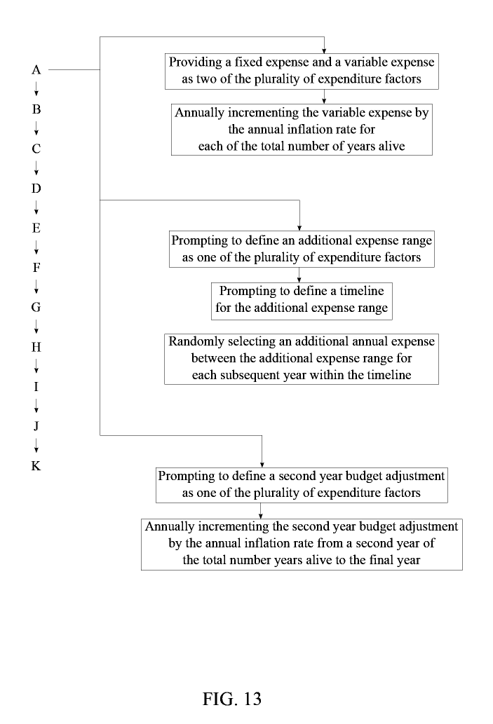

In reference to FIG. 3 and FIG. 13, the plurality of expense factors that defines different expenses within the present invention includes a fixed expense, a variable expense, an extraordinary expense, an additional annual expense, and a second year budget adjustment. The fixed expense is the simplest expense factor and defines expenses which are presumed to be held constant throughout the total number of years alive covered by the present invention. Some of the fixed expenses may be subject to elimination at certain points during the present invention; cessation of mortgage payments for example. Other examples of the fixed expense include life insurance premiums and auto loan payments.

In reference to FIG. 13, the variable expense varies for each year of the total number of years alive within the present invention and depends upon the annual inflation rate. More specifically, the present invention annually increments the variable expense by the annual inflation rate for each of the total number of years alive. Examples of the variable expense include food, utilities, fuel, and entertainment as the variable expense is also subjected to alteration by the death expense factor.

In reference to FIG. 13, the extraordinary expense is intended to represent random expenses, such as medical bills, which may occur over the total number of years alive. The extraordinary expense parameter injects a degree of uncertainty into the simulation, which helps the user in making the most robust plan possible as the present invention is accounting even for random chance in the area of expenses. More specifically, the present invention prompts the user to define the extraordinary expense for the household entity and an occurrence year for the extraordinary expense. Then the present invention is able to apply the extraordinary expense into the calculation so that the outcome of the present invention can be updated accordingly.

The additional annual expense comprises randomized value within value or a constant value within a range which is set by the user and is applied to the user's financial inventory on a yearly basis as the limits of the additional annual expense are defined by the user. The additional annual expense can include, but is not limited to, additional educational expenses, additional premiums to cover new risk, and additional insurance payments. More specifically, the present invention prompts the user to define an additional expense range as for the household entity and a timeline for the additional expense range. For example, the timeline can be any number of years within the total number years alive. When the additional annual expense range is defined to be randomized, the present invention randomly selects the additional annual expense between the additional expense range for each subsequent year within the timeline as the additional expense range provides a maximum and a minimum value that the additional annual expense can range. However, when the additional annual expense range is defined to be a constant value, the present invention utilizes the defined constant value for each subsequent year within the timeline.

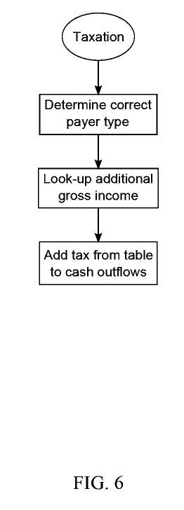

In reference to FIG. 13, a second provision is made for the second year budget adjustment, where the second year adjustment provides a one-time budget adjustment that reduces or increases variable expenses as the reduction of expense is defined as negative number and increase of expense is defined as positive number. The effect of which is carried through the present invention until the assignee entity with the death expense factor reaches the death year or until the final year. More specifically, the present invention prompts the user to define the second year budget adjustment for the household entity as the present invention annually increments the second year budget adjustment by the annual inflation rate from a second year of the total number of years alive to the final year. In reference to FIG. 6, the present invention also analyzes the taxation information in order to calculate the annual tax payment for the plurality of income factors, where the annual tax payment is recognized as one of the plurality of expenditure factors.

Once the demographic information, the plurality of income factors, and the plurality of expenditure factors are defined with the present invention, the present invention receives a plurality of financial assets. The plurality of financial assets can include, but is not limited to, stocks, bonds, fixed annuity, pension funds, individual retirement accounts, 401k, personal savings, insurance, and mutual funds. Then the plurality of financial assets is totaled into a total asset worth so that the total asset worth can be reinvested. More specifically, the present invention prompts the user to allocate the total asset worth amongst a plurality of investment options so that the user is able to allocate the total asset worth based on the tolerance for risk for each of the plurality of investment options.

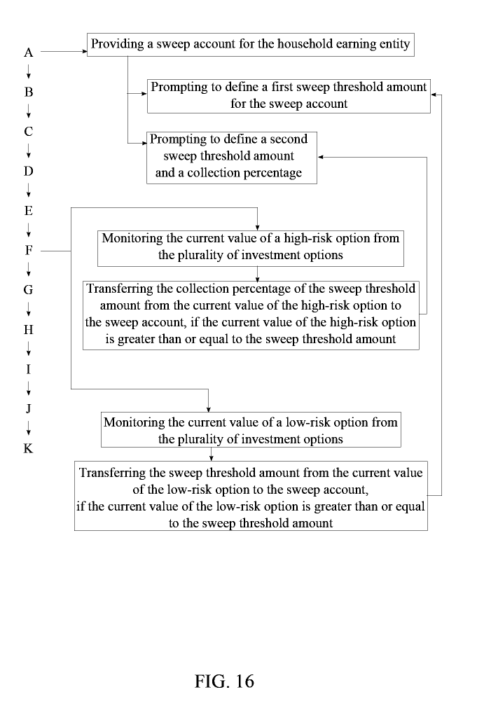

In reference to FIG. 16, Furthermore, the user can select a saved amount from the current annual salary to be allocated amongst the plurality of investment options. More specifically, the present invention calculates the total number of years employed by subtracting the current age from the actual retirement year. Then the saved amount is calculated by applying a saving percentage to the current annual salary, where the saving percentage is defined by the user. The present invention then prompts the user to distribute portions of the saved amount amongst the plurality of investment options, where the portions of the saved amount are added to a current value for the each of the plurality of investment options. The allocations from the saved amount do not need to match up with the allocations from the total asset worth.

In reference to FIG. 10, the plurality of investment options provides a risk and reward strategy and has a performance range that constrains potential maximum loss and maximum gain for each investment year of the total number years alive. The performance range for each of the plurality of investment options is set to a default range with the present invention or is adjust to a user-selected range. The default ranges of the plurality of investment options are initially set based on long term collected data of the plurality of investment options.

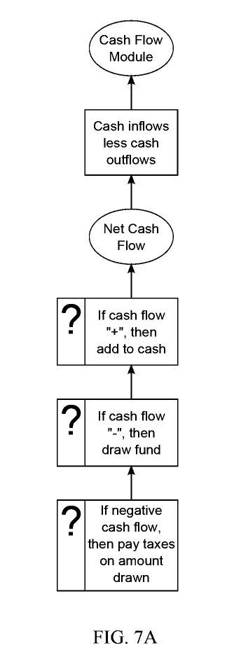

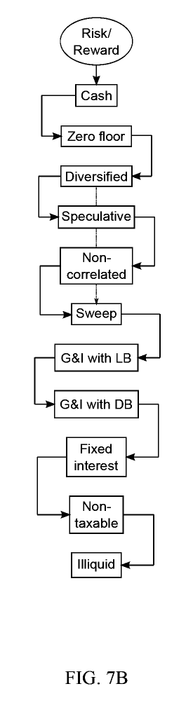

In reference to FIG. 7B, the preferred plurality of investment options and corresponding default ranges are as follows, where the present invention is not limited only to the preferred plurality of investment options and can includes any other type of investment options:
1. Cash option is one of the plurality of investment options that includes highly liquid assets such as passbook savings accounts, certificates of deposit, and brokerage sweep accounts. Cash is preferably defined with a default range of 1% to 3%.
2. Zero floor option is one of the plurality of investment options utilizing financial instruments with near zero risk to principal loss, and do not participate in financial movements less than zero. Principal and credited earnings are guaranteed by either government or large institutional assets. In other words, obligations of U.S. government held to maturity, federally insured bank paper, fixed annuities, A-rated or better corporate obligations. The default range is preferably set between 0% and 12%.
3. Diversified option is one of the plurality of investment options utilizes investment vehicles with low to moderate volatility, and predominantly relating to the U.S. domestic equity markets; for example, large-cap domestic mutual funds or exchange-trade funds (ETF), corporate large cap stock. The default range is preferably set at −39% and +42%.
4. Speculative option is one of the plurality of investment options utilizes investment vehicles with high volatility; for example, sector mutual funds or ETFs, Short ETFs, emerging market securities, leveraged funds, small (less than $500 million) market caps stock. The default range is preferably set between −72% and +80%, giving it a chance for very high gains as well as very severe losses.
5. Uncorrelated option is one of the plurality of investment options uses assets typically uncorrelated with the broad equity markets. These highly speculative instruments carry with them the potential for total loss of principal in any given year or the potential for relatively rapid and large annual gains in asset valuations; i.e. start-up incubator ventures, so-called “disruptive” technology ventures, speculative investment property, commodity futures; the default range is preferably set between −100% and 125%, giving this particular option the most extreme chance for both losses and gains.
6. Sweep option is one of the plurality of investment options utilizes a low risk repository of excess earnings resulting from any of the plurality of investment options which provides monetary returns that exceed a threshold. The threshold is an input parameter and is specified by the user. For example, laddered bond accounts, money markets, and short-term government paper. The default range is preferably set at 1% to 4%.
7. Growth and income with death benefit option is one of the plurality of investment options that typically fixed or variable annuities or life insurance contracts with separately accrued financial benefits immediately accessed by the surviving spouse; the default range is preferably set between 0% and +12% for fixed instruments and between −39% and +42% for variable instruments.
8. Growth and income with living benefit option is one of the plurality of investment that utilizes fixed or variable annuities with an optional income rider guaranteeing a stream of income assuring that the annuitant never runs out of money during their lifetime; the default range is preferably set same as the Growth and income with death benefit option.
9. Tax-exempt option is one of the plurality of investment options that utilizes assets that are typically exempt from federal and/or state income taxation. While encompassing the full range of low to high risk, this option typically involves stable asset values when held to maturity. i.e. insured municipal/state/general obligation bonds; the default range is preferably set between 3% and 6%.
10. Fixed interest option is one of the plurality of investment options that utilizes investments with a consistent, predictable defined cash flow along with stable net asset values, i.e. rental real estate, leasing, corporate collateralized debt programs, general or special purpose bond programs, “alternative” structured investments with stated rates of return. The default range is preferably set between 5% and 7%.
11. Illiquid option is one of the plurality of investment options that includes assets which have a potential liquidation value but lack an income stream; for example, undeveloped land and vacation property. The default range is preferably set between 1% and 2%.

In reference to FIG. 9, once the total asset worth and the saved amount from the current annual salary are distributed amongst the plurality of investment options, the present invention randomly defines an adjustment factor for each of the plurality of investment option for the first year from the total number years alive. More specifically, the adjustment factor is randomly selected from the performance range for each of the plurality of investment options. Then a final value for each of the plurality of investment options for the first year is calculated by applying the adjustment factor to the current value for each of the plurality of investment options for the first year. Then the final value for each of the plurality of investment options for the first year is summed into a total value for each of the plurality of investment options for the first year. The present invention is then able to calculate net assets for the first year by adding the plurality of income factors to the total value of the first year and by subtracting the plurality of expenditure factors from the total value for the first year. Additionally, the present invention also searches for extraordinary expense for the first year, where the first year is recognized as the occurrence year of the extraordinary expense. If the present invention is able to detect any extraordinary expense for the first year, then the net assets for the first year is modified by subtracted by the extraordinary expense.

Then the present invention chooses a randomly defined adjustment factor for each of the plurality of investment options, calculating the final value for each of the plurality of investment options, summing the final value for each of the plurality of investment options, and the calculating the net assets for each subsequent year from the total number years alive in order to determine the net assets for the final year. Additionally, the present invention also calculates the saved amount each of the total number of year employed and automatically distributes the saved amount according to the assigned portions of the saved amount as shown in FIG. 11. When the household earning entity reaches the actual retirement year, the calculation of the saved amount is stopped in according to the stoppage of the current annual salary.

In reference to FIG. 9, the net assets for the final year is defined as a lifetime asset value within the present invention as the present invention randomly defines and selectively applies the annual inflation rate to the plurality of investment options and the plurality of expenditure factors for each subsequent year. More specifically, the annual inflation rate is applied to all different categories of the plurality of expenditure factors except for the fixed expense as the annual inflation rate is randomly selected from a value range that can be a default range, preferably 1% to 4%, within the present invention or a user-selected range for the annual inflation rate.

The process of calculating the lifetime asset value is considered as a single iteration within the present invention. Within the single iteration of the present invention, the present invention is responsible for the development of net cash flow, the sum of all positive cash flows less any negative cash flows, is an integral part of any comprehensive and realistic modeling tool as shown in FIG. 7A. Net cash flow positioning in the overall algorithms of the present invention results in a unique sequencing and serves as a major underpinning in the logic of the present invention. Taken in its entirety, the role of net cash flow and total randomization as a function of method is unique to the present invention. Therefore, the present invention provides solutions that are realistic, credible, and provide a basis for assembling resilient action plans. The present invention uses assumptions that are mainly user defined; how much money is spent expenditures, how long to stay in the labor force. These are all, for the most part, controllable income and expenditure issues while the annual Inflation rate, the annual tax payments, and market gains or losses of the plurality of investment options are not considered as the controllable parameters. Having calculated positive cash flows from the plurality of income factors and negative cash flows from the plurality of expenditure factors, the lifetime asset value can result in either a positive or negative cash flow before taxes. The present invention assumes that funds withdrawn are taxable as ordinary income, with a few exceptions such as municipal bonds and other tax-free instruments. The present invention assumes cash flow drawn down is sufficient to cover the fixed expense and variable expense while the plurality of income factors is insufficient to cover the plurality of expenditure factors, a taxable draw from retirement funds is assumed to take place. This incremental draw is assumed to have its own taxable impact which is added to preliminary annual tax payment which results in a net cash flow.

In reference to FIG. 16, a sweep account for the household earning entity is provided within the present invention, where the present invention prompts the user to define a first sweep threshold amount, a second sweep threshold amount, and a collection percentage. More specifically, the present invention monitors the current value of a low-risk option from the plurality of investment options so that the present invention is able to transfer the first sweep threshold amount from the current value of the low-risk option to the sweep account if the current value of the low-risk option is greater than or equal to the first sweep threshold amount. Similarly, the present invention monitors the current value of a high-risk option from the plurality of investment options so that the present invention is able to transfer the collection percentage of the second sweep threshold amount from the current value of the high-risk option to the sweep account if the current value of the high-risk option is greater than or equal to the second sweep threshold amount.

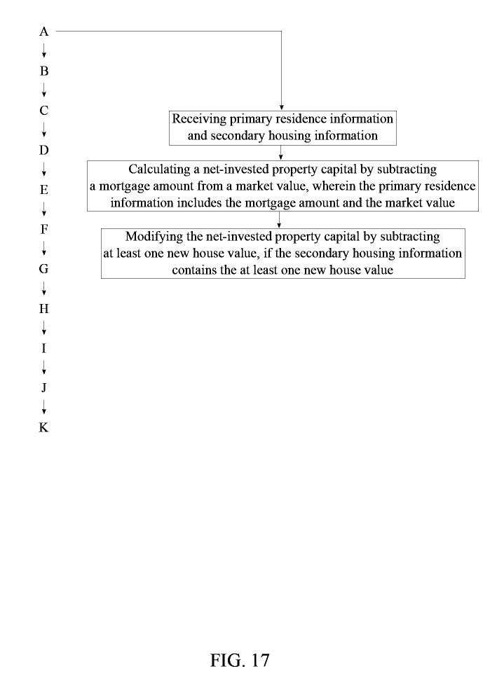

In reference to FIG. 17, the present invention allows flexibility to modified the lifetime asset value by providing the option to have the calculation include the sale of the primary residence; this is very useful for many users as many retired household entities often sell the primary residence and downgrade to a smaller home which is cheaper and easier to maintain. More specifically, the present invention receives primary residence information and secondary housing information so that the received information can be utilized within the present invention to further modifies the lifetime asset value. In reference to FIG. 4, the primary residence information and secondary housing information can include, but are not limited to, a purchase price, amount of indebtedness, date of origination, a market value, an interest rate and terms, rate of annual increase in value, at least one new house value, when to sell when to pay off mortgage early, or utilize a reverse mortgage that can perform as one of the plurality of income factors. Through this residence information, the present invention is able to account for all financial aspects of the primary residence information and secondary housing information. Then a net-invested property capital is calculated by subtracting a mortgage amount of the primary residence from the market value of the primary residence. Then the net-invested property capital is modified by subtracting the least one new house value, if the secondary housing information contains the at least one new house value.

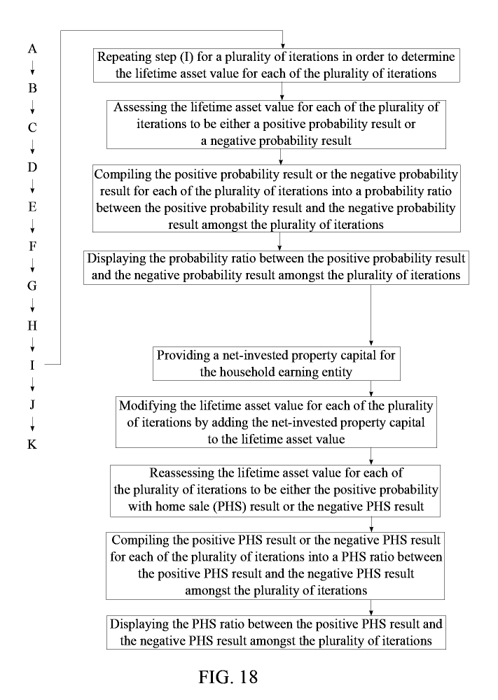

In reference to FIG. 18, the present invention utilizes a plurality of iterations in order to determine the lifetime asset values for the plurality of iterations. Importantly, the present invention is able to execute rapid multiple iterations from a minimum of fifty to several thousand if desired. Each iteration, whether a one single iteration or the plurality of iterations tests a particular set of user controlled assumptions against randomly generated rates of return outcome. More specifically, the calculation for the lifetime asset values form the first year to the final year is repeated multiple times within the present invention so that the present invention is able to assess the lifetime asset values for each of the plurality of iteration to be either a positive probability result or a negative probability result. Then the positive probability result or the negative probability result for each of the plurality of iterations is compiled into a probability ratio between the positive probability result and the negative probability result amongst the plurality of iterations, where the probability ratio determines the probability of running out of money prematurely. Then the present invention is able to display the probability ratio between the positive probability result and the negative probability result amongst the plurality of iteration. The probability ratio is displayed with a complete summary of graphical and numerical result calculations of the present invention.

The randomization of the adjustment factor, the annual inflation rate, the variable expense, and the variable retirement earning within the present invention accounts for total randomization with sample replacement. For example, if the present invention selects 3% as the annual inflation rate for a specific year of the total number of years alive, the present invention does not eliminate 3% annual inflation rate for the value range enabling the present invention to select 3% annual inflation rate again. As a result, the present invention is able to achieve unbiased randomization for calculations with a high degree of confidence. Since the primary residence information provides additional asset for the household earning entity, the present invention is able utilize the primary residence information to modify the lifetime asset value for each of the plurality of iterations by adding the net-invested property capital to the lifetime asset value. Then the present invention is able to reassess the lifetime asset value for each of the plurality of iterations to be either the positive probability with home sale (PHS) result or the negative PHS result. The positive PHS result or the negative PHS result for each of the plurality of iterations is compiled into a PHS ratio between the positive PHS result and the negative PHS result amongst the plurality of iterations as the present invention displays the PHS ratio between the positive PHS result and the negative PHS result amongst the plurality of iterations.

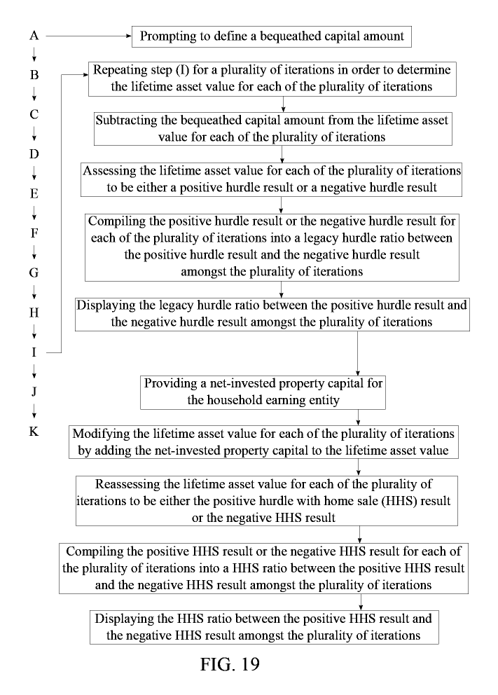

In reference to FIG. 19, the present invention also prompts to define a bequeathed capital amount upon user's discretion. More specifically, the calculation for the lifetime asset values form the first year to the final year is repeated multiple times within the present invention so that the present invention is able to assess the lifetime asset values for each of the plurality of iteration. Then the bequeathed capital amount is subtracted from the lifetime asset value for each of the plurality of iterations in order to assess the lifetime asset value for each of the plurality of iteration to be either a positive hurdle result or a negative hurdle result. Then the positive hurdle result or the negative hurdle result for each of the plurality of iterations is compiled into a legacy hurdle ratio between the positive hurdle result and the negative hurdle result amongst the plurality of iterations, where the legacy hurdle ratio determines the probability of achieving the legacy hurdle. Then the present invention is able to display the legacy hurdle ratio between the positive hurdle result and the negative hurdle result amongst the plurality of iteration.

The primary residence information can also utilize within the present invention in order to modify the lifetime asset value for each of the plurality of iterations by adding the net-invested property capital to the lifetime asset value. Then the present invention is able to reassess the lifetime asset value for each of the plurality of iterations to be either the positive hurdle with home sale (HHS) result or the negative HHS result. The positive HHS result or the negative HHS result for each of the plurality of iterations is compiled into a HHS ratio between the positive HHS result and the negative HHS result amongst the plurality of iterations as the present invention displays the HHS ratio between the positive HHS result and the negative HHS result amongst the plurality of iterations.

The present invention can include two separate versions, an expanded version and a light version. Within each of these two versions, there are two sub-versions; one specialized to handle the single individual and one specialized for two individuals. These two sub-versions ultimately only vary in parts of the define demographic information, the plurality of income factors, and the plurality of expenditure factors, as the single individual and two individuals sub-versions have different requirements for what needs to be input in order to properly run the calculation. The expanded version of the software includes the maximum number of input parameters which can be manipulated by the user. As such, the expanded version of the software can account for more possible occurrences within the calculation. The light version of the software has less input parameters, and is less complex. It is therefore much simpler and easier to use, but it cannot account for as many possible occurrences within the calculation. The light version provides an option for those who may be less financially and technically inclined, or who simply want a quick estimate of the probability ratio. Regardless, the user is free to choose which version and sub-version is the best fit for their purposes.

Although the invention has been explained in relation to its preferred embodiment, it is to be understood that many other possible modifications and variations can be made without departing from the spirit and scope of the invention as hereinafter claimed.

What is claimed is:

1. A method of determining sufficient financial resources for retirement by executing computer-executable instructions stored on a non-transitory computer-readable medium, the method comprises the steps of:
(A) prompting to define demographic information, a plurality of income factors, and a plurality of expenditure factors for a household earning entity;
(B) analyzing the demographic information in order to calculate a total number of years alive for the household earning entity;
(C) receiving and totaling a plurality of financial assets into a total asset worth;
(D) prompting to allocate the total asset worth amongst a plurality of investment options;
(E) randomly defining an adjustment factor for each of the plurality of investment options for a first year from the total number years alive;
(F) calculating a final value for each of the plurality of investment options for the first year by applying the adjustment factor to a current value for each of the plurality of investment options for the first year;
(G) summing the final value for each of the plurality of investment options for the first year into a total value for the plurality of investment options for the first year;
(H) calculating net assets for the first year by adding the plurality of income factors to the total value of the first year and by subtracting the plurality of expenditure factors from the total value for the first year;
(I) repeating steps (E) through (H) for each subsequent year from the total number of years alive in order to determine the net assets for a final year from the total number of years alive;
(J) randomly defining and selectively applying an annual inflation rate to the plurality of expenditure factors and the plurality of investment options for each subsequent year; and
(K) defining the net assets for the final year as a lifetime asset value.

2. The method of determining sufficient financial resources for retirement by executing computer-executable instructions stored on a non-transitory computer-readable medium, the method as claimed in claim 1 comprises the steps of:
randomly selecting the adjustment factor between a performance range for each of the plurality of investment options, wherein the performance range is a default range or a user-selected range.

3. The method of determining sufficient financial resources for retirement by executing computer-executable instructions stored on a non-transitory computer-readable medium, the method as claimed in claim 1 comprises the steps of:
randomly selecting the annual inflation rate between a value range, wherein the value range is a default range or a user-selected range.

4. The method of determining sufficient financial resources for retirement by executing computer-executable instructions stored on a non-transitory computer-readable medium, the method as claimed in claim 1 comprises the steps of:
wherein the demographic information includes a current age, a current year, and a death age; and
calculating the total number of years alive by subtracting the current age from the death age.

5. The method of determining sufficient financial resources for retirement by executing computer-executable instructions stored on a non-transitory computer-readable medium, the method as claimed in claim 1 comprises the steps of:
(L) wherein the demographic information includes a current age, a current year, and an actual retirement year;
(M) providing a current annual salary as one of the plurality of income factors;
(N) calculating a total number of years employed by subtracting the current age from the actual retirement year;
(O) calculating a saved amount by applying a savings percentage to the current annual salary;
(P) prompting to distribute portions of the saved amount amongst the plurality of investment options;
(Q) adding the portions of the saved amount to the current value for each of the plurality of investment options; and
(R) executing steps (M) through (O) for each of the total number of years employed.

6. The method of determining sufficient financial resources for retirement by executing computer-executable instructions stored on a non-transitory computer-readable medium, the method as claimed in claim 1 comprises the steps of:
providing a fixed retirement earning and a variable retirement earning as two of the plurality of income factors; and
annually incrementing the variable retirement earning by the annual inflation rate from an eligible retirement year to the final year, wherein the number of years alive includes the eligible retirement year and the final year.

7. The method of determining sufficient financial resources for retirement by executing computer-executable instructions stored on a non-transitory computer-readable medium, the method as claimed in claim 1 comprises the steps of:
providing a fixed expense and a variable expense as two of the plurality of expenditure factors; and
annually incrementing the variable expense by the annual inflation rate for each of the total number of years alive.

8. The method of determining sufficient financial resources for retirement by executing computer-executable instructions stored on a non-transitory computer-readable medium, the method as claimed in claim 1 comprises the steps of:
prompting to define an additional expense range as one of the plurality of expenditure factors;
prompting to define a timeline for the additional expense range; and
randomly selecting an additional annual expense between the additional expense range for each subsequent year within the timeline.

9. The method of determining sufficient financial resources for retirement by executing computer-executable instructions stored on a non-transitory computer-readable medium, the method as claimed in claim 1 comprises the steps of:
prompting to define a second year budget adjustment as one of the plurality of expenditure factors; and
annually incrementing the second year budget adjustment by the annual inflation rate from a second year of the total number years alive to the final year.

10. The method of determining sufficient financial resources for retirement by executing computer-executable instructions stored on a non-transitory computer-readable medium, the method as claimed in claim 7 comprises the steps of:
wherein the household earning entity includes a first earner and a second earner;
wherein the demographic information includes a death expense factor, a first death age for the first earner, and a second death age for the second earner;
comparing the first death age to the second death age in order to identify an assignee entity for the death expense factor, wherein the assignee entity has an earlier death age; and
applying the death expense factor to the variable expense,
if the assignee entity reaches the earlier death age.

11. The method of determining sufficient financial resources for retirement by executing computer-executable instructions stored on a non-transitory computer-readable medium, the method as claimed in claim 1 comprises the steps of:
prompting to define an extraordinary expense for the household earning entity and an occurrence year for the extraordinary expense; and
modifying the net assets of the occurrence year by subtracting the extraordinary expense.

12. The method of determining sufficient financial resources for retirement by executing computer-executable instructions stored on a non-transitory computer-readable medium, the method as claimed in claim 1 comprises the steps of:
wherein the demographic information includes taxation information; and
analyzing taxation information in order to calculate an annual tax payment, wherein the annual tax payment is one of the plurality of expenditure factors.

13. The method of determining sufficient financial resources for retirement by executing computer-executable instructions stored on a non-transitory computer-readable medium, the method as claimed in claim 1 comprises the steps of:
providing a sweep account for the household earning entity;
prompting to define a first sweep threshold amount for the sweep account;
monitoring the current value of a low-risk option from the plurality of investment options; and
transferring the sweep threshold amount from the current value of the low-risk option to the sweep account,
if the current value of the low-risk option is greater than or equal to the sweep threshold amount.

14. The method of determining sufficient financial resources for retirement by executing computer-executable instructions stored on a non-transitory computer-readable medium, the method as claimed in claim 1 comprises the steps of:
providing a sweep account for the household earning entity;
prompting to define a second sweep threshold amount and a collection percentage;
monitoring the current value of a high-risk option from the plurality of investment options; and
transferring the collection percentage of the sweep threshold amount from the current value of the high-risk option to the sweep account,
if the current value of the high-risk option is greater than or equal to the sweep threshold amount.

15. The method of determining sufficient financial resources for retirement by executing computer-executable instructions stored on a non-transitory computer-readable medium, the method as claimed in claim 1 comprises the steps of:
receiving primary residence information and secondary housing information;
calculating a net-invested property capital by subtracting a mortgage amount from a market value, wherein the primary residence information includes the mortgage amount and the market value; and
modifying the net-invested property capital by subtracting at least one new house value,
if the secondary housing information contains the at least one new house value.

16. The method of determining sufficient financial resources for retirement by executing computer-executable instructions stored on a non-transitory computer-readable medium, the method as claimed in claim 1 comprises the steps of:
repeating step (I) for a plurality of iterations in order to determine the lifetime asset value for each of the plurality of iterations;
assessing the lifetime asset value for each of the plurality of iterations to be either a positive probability result or a negative probability result;
compiling the positive probability result or the negative probability result for each of the plurality of iterations into a probability ratio between the positive probability result and the negative probability result amongst the plurality of iterations; and
displaying the probability ratio between the positive probability result and the negative probability result amongst the plurality of iterations.

17. The method of determining sufficient financial resources for retirement by executing computer-executable instructions stored on a non-transitory computer-readable medium, the method as claimed in claim 16 comprises the steps of:
providing a net-invested property capital for the household earning entity;
modifying the lifetime asset value for each of the plurality of iterations by adding the net-invested property capital to the lifetime asset value;
reassessing the lifetime asset value for each of the plurality of iterations to be either the positive probability with home sale (PHS) result or the negative PHS result;
compiling the positive PHS result or the negative PHS result for each of the plurality of iterations into a PHS ratio between the positive PHS result and the negative PHS result amongst the plurality of iterations; and
displaying the PHS ratio between the positive PHS result and the negative PHS result amongst the plurality of iterations.

18. The method of determining sufficient financial resources for retirement by executing computer-executable instructions stored on a non-transitory computer-readable medium, the method as claimed in claim 1 comprises the steps of:
prompting to define a bequeathed capital amount;
repeating step (I) for a plurality of iterations in order to determine the lifetime asset value for each of the plurality of iterations;
subtracting the bequeathed capital amount from the lifetime asset value for each of the plurality of iterations;
assessing the lifetime asset value for each of the plurality of iterations to be either a positive hurdle result or a negative hurdle result;
compiling the positive hurdle result or the negative hurdle result for each of the plurality of iterations into a legacy hurdle ratio between the positive hurdle result and the negative hurdle result amongst the plurality of iterations; and
displaying the legacy hurdle ratio between the positive hurdle result and the negative hurdle result amongst the plurality of iterations.

19. The method of determining sufficient financial resources for retirement by executing computer-executable instructions stored on a non-transitory computer-readable medium, the method as claimed in claim 18 comprises the steps of:
providing a net-invested property capital for the household earning entity;
modifying the lifetime asset value for each of the plurality of iterations by adding the net-invested property capital to the lifetime asset value;
reassessing the lifetime asset value for each of the plurality of iterations to be either the positive hurdle with home sale (HHS) result or the negative HHS result;
compiling the positive HHS result or the negative HHS result for each of the plurality of iterations into a HHS ratio between the positive HHS result and the negative HHS result amongst the plurality of iterations; and
displaying the HHS ratio between the positive HHS result and the negative HHS result amongst the plurality of iterations.

20. The method of determining sufficient financial resources for retirement by executing computer-executable instructions stored on a non-transitory computer-readable medium, the method as claimed in claim 1 comprises the steps of:
providing an current annual salary as one of the plurality of income factors;
receiving a wage inflation rate for the household earning entity; and
annually incrementing the current annual salary by the wage inflation rate from the first year to an actual retirement year, wherein the total number of years alive includes the actual retirement year.
